(19) United States
(12) Patent Application Publication
(10) Pub. No.: US 2016/0344683 A1
(43) Pub. Date: Nov. 24, 2016

(54) NETWORK SWITCH HAVING ADDRESS CONFIGURATION FUNCTION

(71) Applicants: DASAN NETWORKS, INC., Seongnam-si (KR); DASAN NETWORK SOLUTIONS, INC., Seongnam-si (KR)

(72) Inventors: Jae-Sang PARK, Seongnam-si (KR); Seung-Dong LEE, Seoul (KR)

(73) Assignees: DASAN NETWORKS, INC., Seongnam-si (KR); DASAN NETWORK SOLUTIONS, INC., Seongnam-si (KR)

(21) Appl. No.: 15/111,570

(22) PCT Filed: Nov. 5, 2014
(86) PCT No.: PCT/KR2014/010545

§ 371 Date: Jul. 14, 2016

(30) Foreign Application Priority Data
Jan. 16, 2014 (KR) 10-2014-0005707

(51) Int. Cl. H04L 29/12; H04L 12/707

(52) U.S. Cl. CPC H04L 61/20; H04L 45/24; H04L 61/6068; H04L 61/6022

(57) ABSTRACT

A network switch is disclosed, where predetermined terminals are connected to respective ports. The network switch includes an address setter that transmits an address including a physical address to be allocated to the terminals connected to the respective ports, and an address setting command through a corresponding port.

### TECHNICAL FIELD

The following description relates to a network switch, and more specifically to, a network switch with ports, to which are connected by predetermined terminals, respectively.

### BACKGROUND ART

Korean Laid-open Patent Publication No. 10-2013-0086363, filed by Broadcom Corporation, discloses a vehicle communication network. A technology of the vehicle communication network relates to standards of in-vehicle Ethernet, which has been applied to BMW X5 and commercialized. As well known, the Ethernet switches (routers) 10 for vehicles have switch ports which are each connected by terminals according to in-vehicle design specifications, wherein the terminals required to connect respective ports are predetermined. FIG. 1 illustrates an example of an Ethernet switch 10 and terminals connecting thereto, i.e., terminals required to be connected, including an IP camera 20, a telematics 30, a cluster display 40, etc. In other words, the Ethernet switch 10 is designed in a general physical construction, where predetermined application modules, such as a camera, connect respective ports of the Ethernet switch.

The terminals to be connected to the respective ports of the Ethernet switch have physical addresses i.e., media access control (MAC) addresses, and logical addresses i.e., Internet protocol (IP) addresses, which are set in a PHY chip in consideration of the types of vehicles and options thereof when the terminals are manufactured. Thus, in a factory's terminal initialization process, another MAC address is required to be recorded according to each terminal in memory, such as flash memory and electrically erasable programmable read-only memory (EEPROM). For example, the different MAC address according to each terminal is required to be recorded in consideration with the Ethernet switch's ports, which are different according to types/options of a vehicle, as illustrated in FIG. 1 showing that the MAC ID of the camera 20 is #1; the telematics 30, #2; and the cluster display 40, #3. Thus, it is difficult to perform initialization due to the recording process.

### Technical Problem

Provided is a network switch that supports setting of the physical addresses of predetermined terminals that are connected to each of the ports of the network switch.

Provided is a network switch that also supports setting of logical addresses.

### Technical Solution

In one general aspect, a network switch with an address setting function, wherein predetermined terminals are connected to respective ports of the network switch, includes: an address setter to transmit an address and an address setting command through a corresponding port, wherein the address comprises a physical address to be allocated to the terminals that are connected to the respective ports.

The address setter may have an address setting function for transmitting an address to be allocated and the address setting command through a corresponding port in a form of a broadcast packet.

The network switch may further include: storage to store information on the address including the physical address of each port; and an address provider to read, from the storage, the address to be allocated to the terminals connected to the respective ports and provide the read address to the address setter.

The network switch may further include an address provider to send, to an external device, a request for the address including the physical address to be allocated to the terminals connected to the respective ports, and provide the address, received from the external device, to the address setter.

The address setter may have a function of in response to a connection of the terminal being newly recognized in a port that is once unconnected at a time of booting the network switch, transmitting the address and the address setting command through the unconnected port, wherein the address comprises the physical address to be allocated to the newly recognized terminal.

The network switch may further include an address comparer to compare an address received from the terminals connected to the respective ports and an address required to be allocated; and wherein the address setter may have a function of in response to the determination that the address received from the terminals connected to the respective ports is not the same as the address required to be allocated, transmit the address required to be allocated and the address setting command through the port.

The address to be allocated to the terminals connected to the respective ports may further include a logical address.

### Advantageous Effects

The disclosed network switch for a moving object may automatically set a physical address that is required to be allocated to a terminal that is connected to each port. Also, the network switch may automatically set a physical address, as well as a logical address. Accordingly, in the case where a module is first connected to the port of the network switch, or is replaced with a new module due to disorders, etc., so the new module is connected thereto, the network switch may set the physical and logical addresses of the module that is connected to the port. Thus, when terminals are manufactured, it is not necessary to record in memory one by one an address that is required to be allocated to each terminal, so it is easy to initialize the terminal.

In addition, if a port, once unconnected before the rebooting, is connected and recognized at a time when the switch is rebooted, the disclosed network switch for a moving object performs the address setting only regarding a newly connected and recognized terminal, thereby making an effect of avoiding a necessary address setting at every booting.

Furthermore, the disclosed network switch for a moving object receives addresses from terminals connected to the respective ports when the switch is rebooted, compares the received addresses to addresses required to be actually allocated, so as to determine whether they are the same, and if they are not the same, allocates addresses again that are required to be actually allocated, thereby making an effect of enabling a normal address setting even in the case where the terminals connected to the respective ports are replaced/changed.

### DESCRIPTION OF DRAWINGS

FIG. 1 is a diagram illustrating connections between an existing Ethernet switch and predetermined terminals that are connected to the respective ports of the switch.

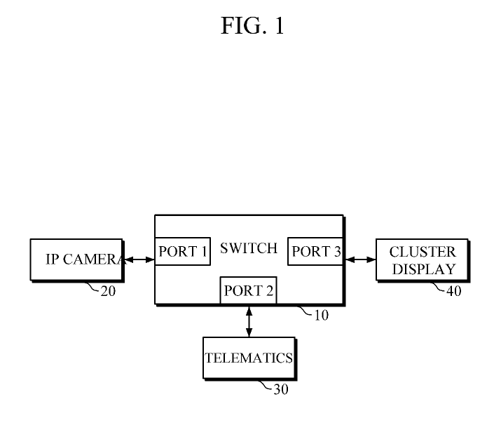

FIG. 2 is a diagram illustrating a network system according to an exemplary embodiment.

FIG. 3 is a diagram illustrating a process of setting physical addresses and logical addresses of terminals connected to respective ports of a network switch according to exemplary embodiment A.

FIG. 4 is a diagram illustrating an example of packets that are transmitted or received in the process according to FIG. 3.

FIG. 5 is a diagram illustrating a process of setting physical and logical addresses of the terminals, which are connected to each of the ports of a network switch according to exemplary embodiment B.

FIG. 6 is a diagram illustrating an example of packets that are transmitted or received in the process according to FIG. 5.

FIG. 7 is a diagram illustrating a process of acquiring physical addresses and logical addresses of terminals, which are connected to each of the ports of a network switch according to an exemplary embodiment.

FIG. 8 is a diagram illustrating an example of packets that are transmitted or received in the process according to FIG. 7.

### MODE FOR INVENTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

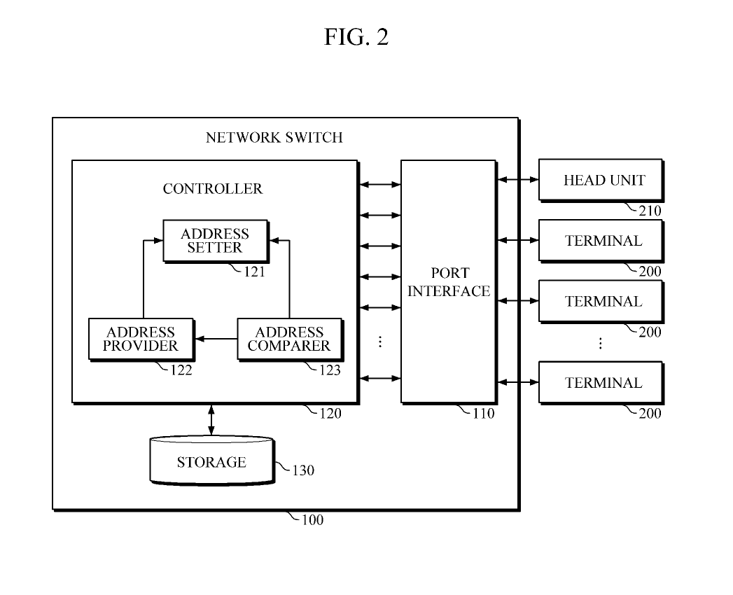

FIG. 2 is a diagram illustrating a network system according to an exemplary embodiment. The network system illustrated in FIG. 2 may be implemented in a moving object. For example, the moving object may be a vehicle. The network system may be an Ethernet system. As illustrated in FIG. 2, the network system includes a network switch 100 and a plurality of terminals 200 that are connected thereto. The terminal 200 being connected to the network switch 100 may be, for example, an IP camera, a telematics, a cluster display, etc. In addition, the terminal may be, for example, a head unit 210. The head unit 210 may communicate with the outside by using a modem.

The network switch 100 includes a port interface 110 and a controller 120. The port interface 110 provides ports that are connected to the terminals 200, and is in charge of transmitting or receiving data to or from the terminals 200 that are connected using the ports. Since the terminals required to be connected to each of the ports are predetermined, the predetermined terminals must be connected to each port. Such a controller 120 may include an address setter 121. In addition, the controller 120 may further include an address provider 122, as well as an address comparer 123. The address setter 121, the address provider 122, and the address comparer 123 may be each configured in a separate software module or a single application, and then implemented by a processor.

The address setter 121 may set addresses of the terminals 200, and more specifically, set the addresses of the terminals 200 by classifying the addresses to each port. For example, the address setter 121 may set address A in the terminal 200 that is connected to port 1; and set address B in the terminal 200 that is connected to port 2. Here, the addresses set to the terminals 200 include physical addresses, i.e., MAC addresses, and logical addresses, i.e., IP addresses. The address setter 121 transmits the addresses required to be allocated to each port, as well as an address setting command, to the corresponding terminal 200 through the corresponding port of the port interface 110. In other words, the address setter 121 transmits the data including address A and an address setting command through port 1 to the terminal 200 that is connected to port 1; and through port 2, the data including address B and an address setting command to the terminal 200 that is connected to port 2. The address setter 121 may form the data including the address and the address setting command into the form of a broadcast packet, thereby transmitting the broadcast packet. Accordingly, the terminals 200 may receive the addresses that have been allocated to themselves, and according to the address setting command, record the received addresses in the memory for the address setting, thus finishing the setting. Here, the memory for address setting may be EEPROM or flash memory.

The network switch 100 may further include storage 130 and an address provider 122. The storage 130 stores an address setting table. In this address setting table, address information that will be allocated to the terminals connected to the respective ports is recorded. In the address setting table, MAC addresses and IP addresses of each port are recorded. For reference, one example of the address setting table is represented below in Table 1.

TABLE 1

| Port | MAC | IP |
|---|---|---|
| 1 | 20-D0-CB-00-00-0B | 192.168.0.11 |
| 2 | 20-D0-CB-00-00-0C | 192.168.0.12 |
| 3 | 20-D0-CB-00-00-0D | 192.168.0.13 |
| 4 | 20-D0-CB-00-00-0E | 192.168.0.14 |
| Switch | 20-D0-CB-00-00-01 | 192.168.0.1 |

The address provider 122 provides the address setter 121 with a physical address that will be allocated to the terminal 200 that is connected to each port. The address provider 122 searches for the address setting table that is stored in the storage 130, and reads the address information that will be allocated to the terminal 200 that is connected to each port. Then, the read address information of each port is provided to the address setter 121. Accordingly, the address setter 121 performs an operation for with the provided address information of each port, setting an address that is required to be allocated to the terminal 200 connected to each port.

The address provider 122 may not use the address setting table, but send a request for address information of each port to an external device that is located outside of the network switch 100. Here, the external device receiving the request for the address information of each port may be a head unit 210. The head unit 210 returns the requested address information of each port to the network switch 100. The head unit 210 may, for example, have address information that will be allocated to the terminals connected to the respective ports, or may request the information to and receive the information including this information from a server over external networks. Then, the head unit 210 returns, to the network switch 100, the address information of each port, which is already included therein or has been provided from the outside. Accordingly, the address provider 122 receives the address information of each port from the head unit 210, and then provides the address information to the address setter 121. The address provider 122 may generate the address setting table, as shown above, using the address information received from the head unit 210, and store it in the storage 130.

If the network switch recognizes a new connection of the terminal 200 to a port that was not connected at a time when the network switch 100 is rebooted, the address setter 121 may transmit, to the terminal 200, an address that will be allocated to the newly recognized terminal and an address setting command through the unconnected port. In other words, if the port that was not connected to the terminal 200 before the rebooting, but is recognized as newly being connected at a time of the rebooting, the network switch 100 transmits, to the newly connected terminal, the address that will be allocated and an address setting command to the unconnected port. In addition, the address setter 121 does not set the addresses for all the terminals 200 that are connected to the respective ports at a time of the rebooting of the network switch 100, but sets the address only for a newly connected terminal. Thus, unnecessary waste of resources may be prevented at every rebooting.

The controller 120 may further include an address comparer 123. In the case where the network switch 100 is rebooted, the address comparer 123 compares setting addresses, received from the terminals 200 connected to the respective ports, to addresses that will be allocated to the terminals 200 transmitted the setting addresses. Here, the address that will be allocated to the terminal 200 may be seen through the address setting table. Then, in response to the comparison result of the address comparer 123, which indicates that the setting address and the address are not identical to each other, the address setter 121 transmits the address that will be allocated to the terminal 200 that has transmitted the setting address, and the address setting command to the terminal 200 through the corresponding port. Here, the corresponding port indicates the port through which the network switch 100 has received the setting address from the terminal 200. Accordingly, the terminal 200 may record the address, received from the network switch 100, in the memory for the address setting, and set the received address to the address that needs to be actually allocated, thereby finishing the setting. In addition, when the network switch 100 is rebooted, the address setter 121 may not set the addresses regarding all the terminals 200 connected to the respective ports, but set again only the wrong ones among the addresses that have been received from the terminal 200. Also, when the network switch 100 is rebooted, even the terminal 200 whose address is not set may transmit an empty address to the network switch 100; thus, even in this case, the address is determined to be wrong, so the address setter 121 may set the empty address to an address that is required to be actually allocated.

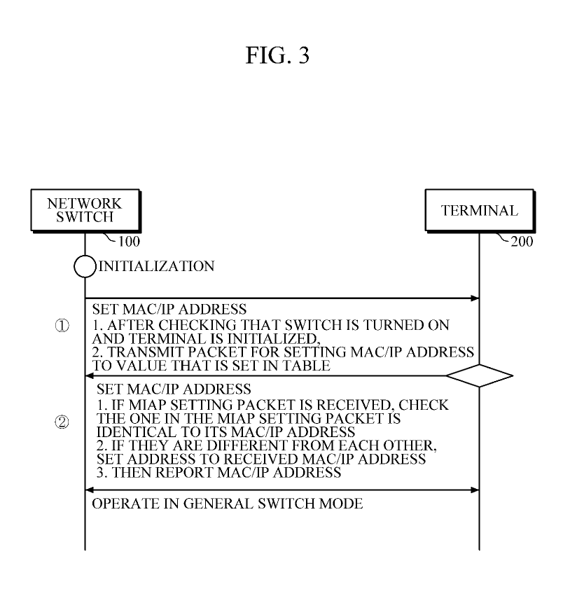

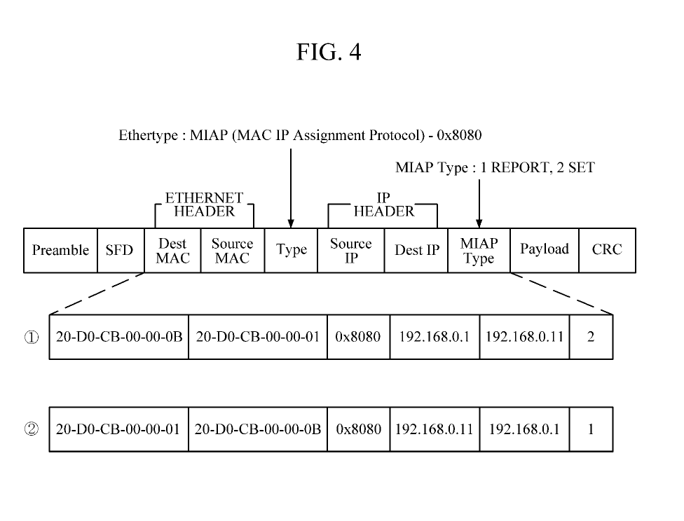

FIG. 3 is a diagram illustrating a process of setting physical addresses and logical addresses of the terminals to be connected to the respective ports of a network switch according to exemplary embodiment A. FIG. 4 is a diagram illustrating an example of packets that are transmitted or received in the process according to FIG. 3. First, a network switch 100 performs initialization, and to a terminal 200 that is connected to a port, transmits packet \textcircled{1} for setting a MAC/IP address through the connected port. In one exemplary embodiment, the network switch 100 checks a port that is activated and connected by the terminal 200, finds the MAC/IP address of the checked port in an address setting table, generates the packet \textcircled{1} for setting the address of the terminal 200 to the found MAC/IP address, and transmits the packet \textcircled{1} through the port that is connected by the terminal 200. Then, the terminal 200, received the packet \textcircled{1}, may set the MAC/IP address and transmit packet \textcircled{2} for reporting the setting completion. Then, the network switch 100 receiving the report on the address setting completion may operate in a general switch mode, and communicate with the terminal 200.

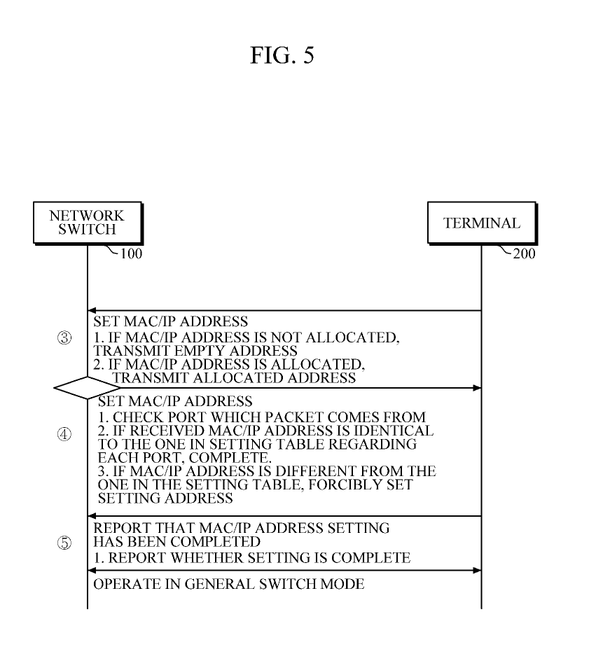

FIG. 4 illustrates a format of packets being transmitted or received between a network switch 100 and a terminal 200 as described in the above-mentioned process. As illustrated in FIG. 4, the packets include an Ethernet header and an IP header. A type field refers to a type of the packet, wherein in this field, a value that indicates a MAC IP assignment protocol (MIAP) is recorded. As illustrated, the MIAP value is ‘0x8080’. A MIAP type field records a value, which represents whether the packet is the one for reporting or for address setting. As illustrated, ‘1’ refers to the reporting, and ‘2’ refers to the setting. FIG. 4 also illustrates an example of packets \textcircled{1} and \textcircled{2} of FIG. 5. Specifically, the packet \textcircled{1} is an example of the packet transmitted from the network switch 100 to the terminal 200; and the packet \textcircled{2}, an example of the packet transmitted from the terminal to the network switch 100. The packet \textcircled{1} is the one for setting the MAC/IP address, which in other words, refers to the one for setting the MAC address of the terminal to ‘20-D0-CB-00-00-0B’, and the IP address to ‘192.168.0.11’, as set in the address setting table. The packet \textcircled{2} is the one that reports that the MAC/IP address has been successfully installed.

Meanwhile, referring to FIG. 3, an example of the network switch 100 that transmits the MIAP packet to the terminal 200 is described. The network switch 100 must transmit data to each port before the process of the MIAP is complete. The purpose thereof is to enable the terminal 200 receiving the data to recognize the data unconditionally as the one that has been transmitted to itself. To this end, a technology of transmitting the data to each port is required to be used. Using, for example, a virtual local area network (VLAN) technology, the data intended to be set for each port may be transmitted in the form of a broadcast packet. The network switch 100 does not operate as a general switch until the MIAP assignment is not complete. In another example, in the case where the network switch 100 is a managed switch, the network switch 100 may select the port and transmit data, so even if the data is not transmitted to each port with the configuration of the VLAN, etc., the network switch 100 is capable of selecting the port and transmitting the data.

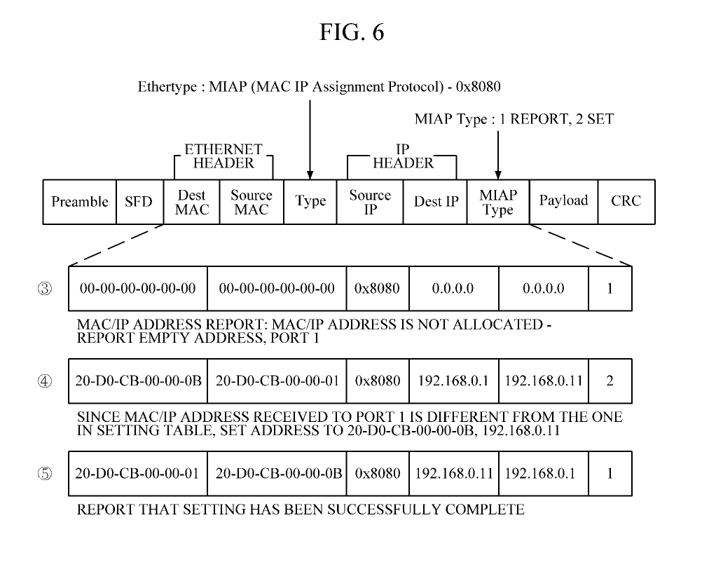

FIG. 5 is a diagram illustrating a process of setting physical and logical addresses of the terminals, which are connected to the respective ports of a network switch according to exemplary embodiment B. FIG. 6 is a diagram illustrating an example of packets that are transmitted or received in the process according to FIG. 5. For example, FIG. 5 may illustrate a process that is performed in the case where the network switch 100 is rebooted. A terminal 200 transmits packet \textcircled{3} for reporting a MAC/IP address to the network switch 100. In the case where the MAC/IP address is not allocated to the terminal 200, the terminal 200 transmits an empty address, whereas in the case where the MAC/IP address is allocated, the terminal 200 transmits the allocated address. In a case of the former, the terminal 200 may newly connect an empty port, and the MAC/IP address may not yet be allocated to the terminal 200. In a case of the latter, before the network switch 100 is rebooted, the MAC/IP address has been already allocated to the terminal 200, which may then set the MAC/IP address to the allocated address.

The network switch 100, receiving the report of the MAC/IP address from the terminal 200, transmits packet \textcircled{4} for setting the MAC/IP address of the terminal 200. Specifically, a controller 120 of the network switch 100 checks through which port the packet comes in, finds the MAC/IP address of the checked port in the address setting table, and then finish the address setting if the MAC/IP address found from the address setting table is the same as the received MAC/IP address. Otherwise, the network switch 100 may transmit, to the terminal 200, the packet \textcircled{4} for setting the MAC/IP address to the one that is found from the address setting table. Accordingly, the MAC/IP address is set to the MAC/IP address of the address setting table. After the address setting is finished, the terminal 200 may transmit packet \textcircled{5} for reporting that the MAC/IP address setting is finished. Here, the packet \textcircled{5} may be in the form of a broadcast packet. Afterwards, the network switch 100 may operate in a general switch mode to communicate with the terminal 200.

Meanwhile, FIG. 6 illustrates a format of packets being transmitted or received between a network switch 100 and a terminal 200 as described in the above-mentioned process. As illustrated in FIG. 6, the packets include an Ethernet header and an IP header. A type field refers to a type of the packet, wherein in this field, a value that indicates a MAC IP assignment protocol (MIAP) is recorded. As illustrated, the MIAP value is ‘0x8080’. A MIAP type field records a value, which represents whether the packet is the one for reporting or for address setting. As illustrated, ‘1’ refers to the reporting, and ‘2’ refers to the setting.

FIG. 6 also illustrates an example of packets \textcircled{3}, \textcircled{4}, and \textcircled{5} of FIG. 5. Specifically, the packet \textcircled{3} in FIG. 6 is an example of a packet transmitted from a terminal 200 to a network switch 100; the packet \textcircled{4}, an example of a packet transmitted from the network switch 100 to the terminal 200; and the packet \textcircled{5}, an example of a packet transmitted again from the terminal 200 to the network switch 100. The packet \textcircled{3} is the one for reporting an MAC/IP address, indicating that the MAC/IP address is not allocated. It is determined that the received MAC/IP address at the port 1 is different from the one of the port 1 in the address setting table. Since the received MAC/IP address at the port 1 is different from the one of the port 1 in the address setting table, the packet \textcircled{4} is the one for setting the MAC address of the terminal, connected to the port 1, to ‘20-D0-CB-00-00-0B’, and an IP address to ‘192.168.0.11’. Lastly, the packet \textcircled{5} refers the one that reports that the MAC/IP address has been successfully set.

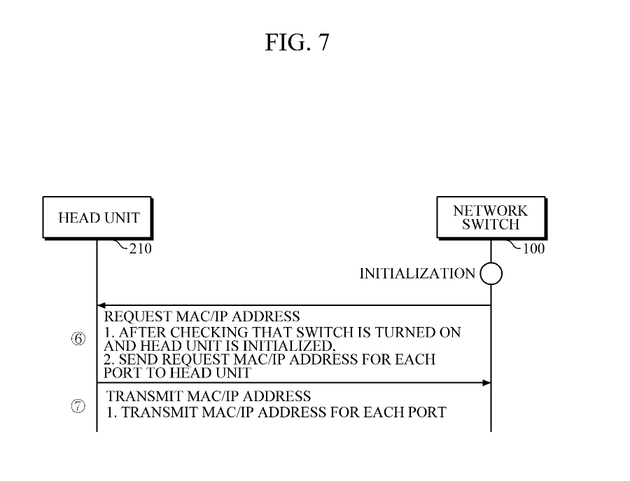

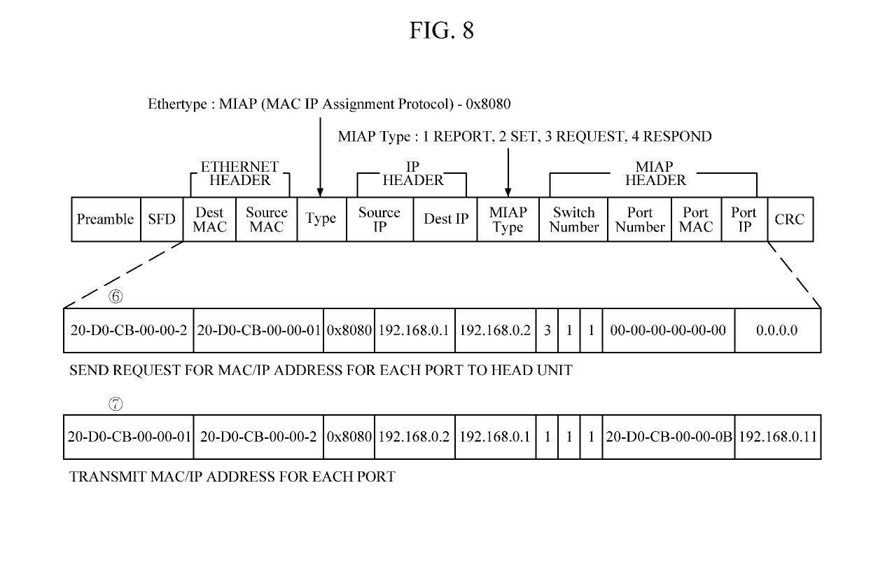

FIG. 7 is a diagram illustrating a process of acquiring physical addresses and logical addresses of terminals that are connected to the respective ports of a network switch according to an exemplary embodiment. FIG. 8 is a diagram illustrating an example of packets that are transmitted or received in the process according to FIG. 7. The network switch 100 performs initialization, and transmits the packet \textcircled{6} for requesting a MAC/IP address to a head unit 210. Specifically, the network switch 100 may confirm that after the switch turns on, the head unit 210 has been initialized, and then transmit the packet \textcircled{6} for requesting the MAC/IP address of each port to the head unit 210. The head unit 210 receiving the packet \textcircled{6} transmits, to the network switch 100, the packet \textcircled{7} for responding to the request for the MAC/IP address for each port.

FIG. 8 illustrates a format of packets being transmitted or received between a network switch 100 and a head unit 210 as described in the above-mentioned process. As illustrated in FIG. 8, the packets include an Ethernet header, an IP header, and a MIAP header. A type field refers to a type of the packet, wherein in this field, a value that indicates a MAC IP assignment protocol (MIAP) is recorded. As illustrated, the MIAP value is ‘0x8080’. A MIAP type field represents whether the packet is the one for reporting, setting, requesting, or responding. As illustrated, ‘1’ refers to the reporting; ‘2’, the setting; ‘3’, the requesting; and ‘4’, the responding. A MIAP header includes a switch number field, a port number field, and a port MAC field, and a port IP field. In the port MAC field and the port IP field, the requested MAC address and IP address are recorded, which is the port number of the switch number.

Also, FIG. 8 illustrates an example of packets \textcircled{6} and \textcircled{7}. The packet \textcircled{6} is an example of the one for requesting a MAC/IP address regarding port 1 of network switch C to a head unit; and \textcircled{7}, an example of the one for responding to the packet \textcircled{6}.

Meanwhile, terminals required to be physically connected to each port of the network switch 100 are determined, but the physical connection may be wrong. In this case, if it cannot be recognized, there would be confusions, e.g., recognizing an IP camera as a telematics, or a cluster display as an IP camera. Thus, in order to prevent these confusions, the network switch 100 may have a function of determining whether terminals required to be connected to the respective ports thereof are connected. For example, the network switch 100 may include terminal identification information of each port. This terminal identification information of each port may be stored in storage 130. The terminal 200 connected to the port may additionally insert its own identification information into a packet transmitted to the network switch 100, which is then transmitted. For example, the terminal 200 may additionally insert its own identification information into a MIAP packet, and then transmit it. Accordingly, the network switch 100 may determine whether the terminal identification information, received from the terminal 200, is the same as the existing terminal identification information of each port by comparing them. If they are different from each other, the network switch 100 may notify to the outside that the connection has been wrong. Alternatively, a function of checking whether the terminal is connected to the corresponding port may be implemented by installing, on a PCB of the network switch 100, a DIP switch that can read an ID of the terminal 200.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

1. A network switch with an address setting function, wherein predetermined terminals are connected to respective ports of the network switch, the network switch comprising:
an address setter configured to transmit an address and an address setting command through a corresponding port, wherein the address comprises a physical address to be allocated to the terminals that are connected to the respective ports.

2. The network switch of claim 1, wherein the address setter has an address setting function for transmitting an address to be allocated and the address setting command through a corresponding port in a form of a broadcast packet.

3. The network switch of claim 1, further comprising:
storage configured to store information on the address including the physical address of each port; and
an address provider configured to read, from the storage, the address to be allocated to the terminals connected to the respective ports and provide the read address to the address setter.

4. The network switch of claim 1, further comprising:
an address provider configured to send, to an external device, a request for the address including the physical address to be allocated to the terminals connected to the respective ports, and provide the address, received from the external device, to the address setter.

5. The network switch of claim 1, wherein the address setter is configured to have a function of in response to a connection of the terminal being newly recognized in a port that is once unconnected at a time of booting the network switch, transmitting the address and the address setting command through the unconnected port, wherein the address comprises the physical address to be allocated to the newly recognized terminal.

6. The network switch of claim 1, further comprising an address comparer configured to compare an address received from the terminals connected to the respective ports and an address required to be allocated; and
wherein the address setter is configured to have a function of in response to the determination that the address received from the terminals connected to the respective ports is not the same as the address required to be allocated, transmit the address required to be allocated and the address setting command through the port.

7. The network switch of claim 1, wherein the address to be allocated to the terminals connected to the respective ports further comprises a logical address.
